(19) United States
(12) Patent Application Publication
(10) Pub. No.: US 2015/0305373 A1
(43) Pub. Date: Oct. 29, 2015

(54) Flavour-Infused Maple Syrup

(71) Applicant: Peter Dewar, Kentville (CA)

(72) Inventor: Peter Dewar, Kentville (CA)

(21) Appl. No.: 14/261,277

(22) Filed: Apr. 24, 2014

(51) Int. Cl. A23L 1/09; A23L 1/221

(52) U.S. Cl. CPC A23L 1/09; A23L 1/221; A23V 2002/00

(57) ABSTRACT

A flavour-infused maple syrup comprising: from about 70% to about 99% by weight of maple syrup produced from maple sap, and from about 1% to about 30% by weight of one or more ingredients selected from the group consisting of herbs, seeds, flowers, spices, fruits, liquid smoke and fermented products, wherein the flavour-infused maple syrup is free of bacteria and mold. Furthermore, a process for producing flavour-infused maple syrup comprising combining maple syrup produced from maple sap with one or more ingredients to form a mixture; heating the mixture to a temperature that eliminates bacteria and mold; allowing the mixture to cool to ambient temperature; maintaining the mixture at ambient temperature for a period of time to allow for infusion of the maple syrup; and reheating the infused maple syrup to eliminate mold and bacteria. The temperature for both heating steps is less than the caramelization temperature of the maple syrup.

### FIELD OF THE INVENTION

The present invention relates to maple syrup produced from maple sap. In particular, it relates to maple syrup infused with natural flavours.

### BACKGROUND

The following description includes information that may be useful in understanding the present invention. It is not an admission that any of the information provided herein is prior art or relevant to the presently claimed invention, or that any publication specifically or implicitly referenced is prior art.

Maple syrup is produced from maple sap that runs during the spring season, in parts of Canada and the northern part of the United States. It has been used as a sweetener in recipes, in addition to imparting a distinct maple flavour in recipes and products such as spreads, teas, candy, sweets, and the like.

In addition, there has been growing interest in the gourmet food industry, where the infusion of flavours has gained popularity.

U.S. Pat. No. 3,294,552 discloses a process of making honey-sugar syrup. The process comprises forming an aqueous mixture of honey and sugar. The amount of honey is between 1%-30% by weight based on the total weight of the composition. The mixture is blended at a temperature of about 145 to 165 F in order to form a homogeneous aqueous solution. The temperature of the solution is then raised to about 165 to 175 F, after which it is filtered, and then placed into containers while maintained at a temperature of about 165 to 175 F. The containers are sealed and maintained at that temperature range for about 5 minutes in order to prevent the sterile product from deterioration upon extended storage. The aqueous mixture of honey and sugar may contain between 5 to 15% by weight maple syrup based on the total weight of the product.

CA 2,477,103 discloses nutritionally-enriched maple syrup which is produced by thermally concentrating maple sap. Nutrients include vitamins such as vitamins B1, C and E. The nutritionally-enriched maple syrup can be added to a variety of foods, given its pleasant flavour.

Acadian Maple Products, based in Nova Scotia (Canada), produces pure maple syrup infused with cinnamon by the addition of a cinnamon stick to the hot syrup as it is bottled (see http://www.acadianmaple.com/products/cinnamon-infused-pure-maple-syrup-250 ml).

Butternut Mountain Farm (Vermon,USA) produces pure maple syrup infused with cinnamon or vanilla by the addition of a cinnamon stick or vanilla bean to the hot syrup as it is bottled (see http://www.butternutmountainfarm.com/our-products?page=shop.browse&category_id=17) .

There are a few countertop recipes for producing infused maple syrup for immediate use found in non-patent literature.

For example, Scout.com (http://cooking scout.com/#/) discloses recipes for producing maple syrup infused with coffee, ginger or cardamom. For each individual recipe, one cup of pure maple syrup is mixed with the ingredient (2 tablespoons of coffee beans; 1 tablespoon of fresh ginger; or ¼^{th} teaspoon of ground cardamom) in a saucepan; the mixture is brought to a boil, removed from heat, covered and allowed to stand for about 20 minutes, strained., and then served.

Dish Dish Family Cookbook (http://dishdish.us/recipe/pumpkin-waffles-with-cinnamon-maple-syrup/) discloses a recipe for cinnamon maple syrup, in which 1 cup of maple syrup is combined with a cinnamon stick. The combination is heated, uncovered, until the syrup begins to steam, after which the heat is turned off. The combination is covered and allowed to stand just before serving.

Fine Cooking (http://www.finecooking com/articles/maple-syrup.aspx?pg=1) discloses a recipe for rosemary-infused maple syrup in which maple syrup is combined with a few sprigs of fresh rosemary; the combination is heated until simmering, after which the heat is turned off. The combination is allowed to steep for 30 minutes.

None of the above countertop recipes, however, teach how to produce a stable, storable product that is free from bacteria and/or mold. Furthermore, the product produced by these recipes may be caramelized due to excess heating of the maple syrup.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The flavour-infused maple syrup and a process for making flavour-infused maple syrup will first be described in their general form, and then the implementation in terms of preferred embodiments will be detailed hereafter. These embodiments are intended to demonstrate the principle of the product and process, and the manner of their implementation. The flavour-infused maple syrup and a process for making flavour-infused maple syrup will then be further described in both broad and more specific forms, and defined, in each of the individual claims which conclude this specification.

In one aspect of the present invention, there is provided a flavour-infused maple syrup comprising from about 70% to about 99% by weight of maple syrup produced from maple sap, and from about 1% to about 30% by weight of one or more ingredients selected from the group consisting of herbs, seeds, flowers, spices, fruits, liquid smoke and fermented products, wherein the flavour-infused maple syrup is free of bacteria and mold.

In another aspect of the present invention, there is provided a process for producing flavour-infused maple syrup, the process comprising: a) combining maple syrup produced from maple sap, with one or more ingredients to form a mixture; b) heating the mixture to a temperature that eliminates bacteria and mold; c) allowing the mixture to cool to ambient temperature; d) maintaining the mixture at ambient temperature for a period of time to allow for infusion of the maple syrup, thereby producing an infused maple syrup; and e) reheating the infused maple syrup to eliminate mold and bacteria; wherein the weight percentage of maple syrup is between 70% and 99% of the total weight of the flavour-infused maple syrup; and the temperature for heating the mixture and the temperature for reheating the infused maple syrup is less than a carmelization temperature of the maple syrup.

In yet another aspect of the present invention there is provided a flavour-infused maple syrup made by the process described above.

The weight percentage of maple syrup can be from about 95% to about 99% by weight of the total mixture. In addition, one or more ingredients can be herbs, seeds, flowers, spices, fruits, liquid smoke, fermented products, or combinations thereof. These ingredients may include vanilla, lavender, chilli, chai tea, lemongrass, chipotle, apple cider vinegar, ginger, cinnamon, nutmeg, anise, clove, fennel and star anise. Furthermore, a flavour-infused maple syrup composition may comprise from about 96% to about 98% by weight of maple syrup produced from maple sap; from about 0.3% to 1% by weight of cinnamon; from about 0.8% to about 1.5% by weight of vanilla paste; and from about 0.25% to about 1% by weight of star anise. Another flavour-infused maple syrup composition may comprise from about 96% to about 99% by weight of maple syrup produced from maple sap; from about 0.3% to 8% by weight of chipotle; from about 0.8% to about 1.5% by weight of lemongrass tea; and from about 0.25% to about 1% by weight of chilies. Yet another flavour-infused maple syrup composition may comprise from about 96% to about 99% by weight of maple syrup produced from maple sap; from about 0.3% to 8% by weight of nutmeg; from about 0.5% to about 1.5% by weight of cinnamon; and from about 0.25% to about 0.8% by weight of cloves. Yet another flavour-infused maple syrup composition may comprise from about 96% to about 99% by weight of maple syrup produced from maple sap; from about 0.3% to 8% by weight of nutmeg; from about 0.5% to about 1.5% by weight of cinnamon; and from about 0.25% to about 0.8% by weight of cloves. Another flavour-infused maple syrup composition may comprise from about 70% to about 85% by weight of maple syrup produced from maple sap; from about 10% to 20% by weight of apple cider vinegar; and from about 2% to about 8% by weight of ginger. The maple syrup used in the flavour-infused maple syrup composition can have a Brix value of from about 66% to about 67%. The flavour-infused maple syrup can be stored for an extended period of time. A sealed bottle of the flavour-infused maple syrup can have a shelf life of at least two years; once opened, it can be resealed and refrigerated to maintain freshness and minimize the formation of crystals due to evaporation of water.

In the process described above, the mixture and the infused maple syrup can be heated to a temperature between 180 F and 190 F. Alternatively, the mixture and the infused maple syrup can be heated to a temperature of 180 F. The one or more ingredients can be selected from the group consisting of vanilla, lavender, chilli, chai tea, lemongrass, chipotle, apple cider vinegar, ginger, cinnamon, nutmeg, anise, clove, fennel and star anise.

The process can include a combination of ingredients such as vanilla, cinnamon and star anise; or chipotle, lemongrass, chilies and liquid smoke; or cinnamon, nutmeg and clove; or ginger and apple cider vinegar; or lavender and chai tea. Furthermore, the process can produce a flavour-infused maple syrup composition that comprises from about 96% to about 98% by weight of maple syrup produced from maple sap; from about 0.3% to 1% by weight of cinnamon; from about 0.8% to about 1.5% by weight of vanilla paste; and from about 0.25% to about 1% by weight of star anise. The process can also produce a flavour-infused maple syrup composition that comprises from about 96% to about 99% by weight of maple syrup produced from maple sap; from about 0.3% to 8% by weight of chipotle; from about 0.8% to about 1.5% by weight of lemongrass tea; and from about 0.25% to about 1% by weight of chilies. The process can further produce a flavour-infused maple syrup composition that comprises from about 96% to about 99% by weight of maple syrup produced from maple sap; from about 0.3% to 8% by weight of nutmeg; from about 0.5% to about 1.5% by weight of cinnamon; and from about 0.25% to about 0.8% by weight of cloves. The process can also produce a flavour-infused maple syrup composition that comprises from about 96% to about 99% by weight of maple syrup produced from maple sap; from about 0.3% to 8% by weight of nutmeg; from about 0.5% to about 1.5% by weight of cinnamon; and from about 0.25% to about 0.8% by weight of cloves. The process can further produce a flavour-infused maple syrup composition that comprises from about 70% to about 85% by weight of maple syrup produced from maple sap; from about 10% to 20% by weight of apple cider vinegar; and from about 2% to about 8% by weight of ginger.

In step (d) of the process, the mixture can be maintained at an ambient temperature for a period of about 24 hours. Furthermore, the process can include the additional steps of e) filtering the infused maple syrup while it is hot; f) transferring the infused maple syrup to a storage vessel that is sterilized; and g) sealing the storage vessel. The maple syrup used in the process can have a Brix value of between 66% and 67%. A sealed bottle of the flavour-infused maple syrup can have a shelf life of at least two years; once opened, it can be resealed and refrigerated to maintain freshness and minimize the formation of crystals due to evaporation of water.

The foregoing summarizes both the principal features and optional aspects of the flavour-infused maple syrup and a process for making the same. The flavour-infused maple syrup and a process for making flavour-infused maple syrup may be further understood by the description of the embodiments which follow.

Wherever ranges of values are referenced within this specification, sub-ranges therein are intended to be included unless otherwise indicated. Where characteristics are attributed to one or another variant, unless otherwise indicated, such characteristics are intended to apply to all other variants where such characteristics are appropriate or compatible with such other variants.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following is given by way of illustration only and is not to be considered limitative of the flavour-infused maple syrup and a process for making flavour-infused maple syrup. Many apparent variations are possible without departing from the scope thereof.

In one embodiment, a stable flavour-infused maple syrup is produced as follows. The ingredients are weighed, and combined with maple syrup in suitable heating vessel (for example, a stainless steel pot). The maple syrup, which is produced from maple sap, can have a Brix level for example, of between 66 and 67%; the maple syrup can be light, dark, or shades in between. The mixture is heated to a temperature that eliminates bacteria and/or mold. This temperature should be below the temperature at which the maple syrup begins to caramelize. As an example, the mixture should not be heated to the point of boiling. The temperature interval for elimination of bacteria and mold can be between 175 F and 190 F, or between 180 F -190 F, or between 185 F-190 F. The mixture can be heated to 180 F, for example.

After the elimination of bacteria and mold is complete, the mixture is removed from the heat, sealed, and allowed to infuse for a minimum period of about 24 hours at ambient temperature. After infusion, the infused product is reheated to a temperature range to eliminate bacteria and mold, as before (without boiling the mixture). While maintaining the elevated temperature, the infused product is filtered, transferred to a sterilized vessel and sealed.

The filtering process can be performed the same way maple syrup is filtered after it is obtained from the evaporation of maple sap. For example, this can include a press that is lined with paper sleeves and clay powder in a series. The heated infused liquid is forced through the filter press which collects extraneous ingredients and/or particles that remain after the infusion process. The filtering process allows the infused maple syrup to have an appearance similar to regular maple syrup, in that no particulate matter is present.

The vessel can be sterilized beforehand, or, sterilized while the heated infused product poured therein. The sterilized vessel can be, for example, a glass bottle. Once the sterilized vessel is sealed, it can be turned upside down for a few minutes, in order to sterilize the vessel lid. Alternatively, the vessel lid can be sterilized beforehand.

As with the first heating step, the temperature interval for elimination of bacteria and mold can be between 175 F and 190 F, or between 180 F-190 F, or between 185 F-190 F. The mixture can be heated to 180 F, for example.

The final product is free of bacteria and/or mold. Furthermore, since the maple syrup is not heated to a temperature where carmelization occurs, the flavour-infused maples syrup is free of caramelized maple syrup.

The infused maple syrup can be further processed to make infused maple syrup products such as hard candy, butter, fudge, and the like.

### Example 1

Maple syrup was infused with cinnamon, nutmeg and clove, in the amounts indicated below.

| Ingredient | 1 L | 10 L | 100 L | Weight % |
|---|---|---|---|---|
| Light Maple syrup (L) | 1 | 10 | 100 | 98.37% |
| Cinnamon sticks (g) | 9.9 | 99.0 | 990.0 | 0.72% |
| Nutmeg (g) | 7.1 | 71.0 | 710.0 | 0.53% |
| Cloves, whole (g) | 5.0 g | 50 g | 500 g | 0.37% |

The ingredients were placed in a stainless steel pot. The maple syrup was added, and the mixture was brought to a temperature of 180 F on a stove. After it reached 180 F, the stove was turned off stove and the heating vessel was covered with a lid. The sealed mixture was allowed to infuse for 24 hours at room temperature. After 24 hours, the infused mixture was placed back on stove and reheated to 180 F. A strainer was prepared with a cloth strainer. The heated infused product was poured though the cloth strainer, and held at 180 F with an induction cooker. The heated infused mixture was then poured into bottles. The bottles were capped, and then placed upside down.

The aforementioned procedure was also used to produce the infused products in Examples 2 through 5.

### Example 2

Maple syrup was infused with chipotle, lemongrass, chilies and liquid smoke in the amounts indicated below.

| Ingredient | 1 L | 10 L | 100 L | Weight % |
|---|---|---|---|---|
| Dark Maple syrup (L) | 1 | 10 | 100 | 97.7% |
| Chipotle, whole (g) | 7.61 | 76.1 | 761 | 0.53% |
| Lemongrass tea (g) | 15.0 | 150.0 | 1500.0 | 1.05% |
| Crushed chilies (g) | 9.5 | 95.0 | 950.0 | 0.67% |
| Liquid smoke (mL) | 2.5 | 25.0 | 250.0 | 0.0002% |

### Example 3

Maple syrup was infused with cinnamon, vanilla and star anise in the amounts indicated below.

| Ingredient | 1 L | 10 L | 100 L | Weight % |
|---|---|---|---|---|
| Light Maple syrup (L) | 1 | 10 | 100 | 97.61 |
| Cinnamon sticks (g) | 9.9 | 99.0 | 990.0 | 0.71 |
| Vanilla Paste (ml) | 15 | 150 | 1500 | 1.1 |
| Star Anise Pods (g) | 7.6 | 76 | 760 | 0.56 |

### Example 4

Maple syrup was infused with apple cider and ginger in the amounts indicated below.

| Ingredient | 1 L | 10 L | 100 L | Weight % |
|---|---|---|---|---|
| Dark Maple syrup (L) | 0.77 | 7.7 | 770 | 77.46 |
| Apple Cider vinegar reduction (L) | 0.230 | 2.3 | 230 | 16.89 |
| Fresh ginger(g) | 77 | 770 | 7.7 kg | 5.65 |

For the apple cider vinegar reduction, the vinegar was boiled down to a 4 to 1 ratio.

### Example 5

Maple syrup was infused with lavender and chai tea in the amounts indicated below.

| Ingredient | 1 L | 10 L | 100 L | Weight % |
|---|---|---|---|---|
| Light Maple syrup (L) | 1 | 1 L | 100 | 98.66 |
| Chai tea (g) | 15.0 | 150.0 | 1500.0 | 1.12 |
| Lavender (g) | 3.0 | 30.0 | 300.0 | 0.22 |

### CONCLUSION

The foregoing has constituted a description of specific embodiments showing how the flavour-infused maple syrup is made. These embodiments are only exemplary. The invention in its broadest, and more specific aspects, is further described and defined in the claims which now follow.

what is claimed:

1. A flavour-infused maple syrup comprising from about 70% to about 99% by weight of maple syrup produced from maple sap, and from about 1% to about 30% by weight of one or more ingredients selected from the group consisting of herbs, seeds, flowers, spices, fruits, liquid smoke and fermented products, wherein the flavour-infused maple syrup is free of bacteria and mold.

2. The flavour-infused maple syrup of claim 1, wherein the one or more ingredients are selected from the group consisting of herbs, seeds, flowers, spices, fruits, liquid smoke and fermented products.

3. The flavour-infused maple syrup of claim 2, wherein the one or more ingredients are selected from the group consisting of vanilla, lavender, chilli, chai tea, lemongrass, chipotle, apple cider vinegar, ginger, cinnamon, nutmeg, anise, clove, fennel and star anise.

4. The flavour-infused maple syrup of claim 3, comprising: from about 96% to about 98% by weight of maple syrup produced from maple sap; from about 0.3% to about 1% by weight of cinnamon; from about 0.8% to about 1.5% by weight of vanilla paste; and from about 0.25% to about 1% by weight of star anise.

5. The flavour-infused maple syrup of claim 3, comprising: from about 96% to about 99% by weight of maple syrup produced from maple sap; from about 0.3% to about 8% by weight of chipotle; from about 0.8% to about 1.5% buy weight of lemongrass tea; and from about 0.25% to about 1% by weight of chilies.

6. The flavour-infused maple syrup of claim 3, comprising from about 96% to about 99% by weight of maple syrup produced from maple sap; from about 0.3% to about 8% by weight of nutmeg; from about 0.5% to about 1.5% by weight of cinnamon; and from about 0.25% to about 0.8% by weight of cloves.

7. The flavour-infused maple syrup of claim 3, comprising: from about 96% to about 99% by weight of maple syrup produced from maple sap; from about 0.3% to about 8% by weight of nutmeg; from about 0.5% to about 1.5% by weight of cinnamon; and from about 0.25% to about 0.8% by weight of cloves.

8. The flavour-infused maple syrup of claim 3, comprising from about 70% to about 85% by weight of maple syrup produced from maple sap; from about 10% to about 20% by weight of apple cider vinegar; and from about 2% to about 8% by weight of ginger.

9. The flavour-infused maple syrup of claim 1, wherein the maple syrup has a Brix value of from about 66% to about 67%.

10. A process for producing flavour-infused maple syrup, the process comprising:
combining maple syrup produced from maple sap, with one or more ingredients to form a mixture;
heating the mixture to a temperature that eliminates bacteria and mold;
allowing the mixture to cool to ambient temperature;
maintaining the mixture at ambient temperature for a period of time to allow for infusion of the maple syrup, thereby producing an infused maple syrup; and
reheating the infused maple syrup to eliminate mold and bacteria,
wherein the maple syrup is from about 70% to about 99% of the total weight of the flavour-infused maple syrup; and the temperature for heating the mixture and the temperature for reheating the infused maple syrup is less than a carmelization temperature of the maple syrup.

11. The process of claim 10, wherein the mixture and infused maple syrup are heated to a temperature from about 180 F to about 190 F.

12. The process of claim 10, wherein the one or more ingredients are selected from the group consisting of herbs, seeds, flowers, spices, fruits, liquid smoke and fermented products.

13. The process of claim 12, wherein the one or more ingredients are selected from the group consisting of vanilla, lavender, chilli, chai tea, lemongrass, chipotle, apple cider vinegar, ginger, cinnamon, nutmeg, anise, clove, fennel and star anise.

14. The process of claim 13, wherein the flavour-infused maple syrup comprises from about 96% to about 98% by weight of maple syrup produced from maple sap; from about 0.3% to about 1% by weight of cinnamon; from about 0.8% to about 1.5% by weight of vanilla paste; and
from about 0.25% to about 1% by weight of star anise.

15. The process of claim 13, wherein the flavour-infused maple syrup comprises from about 96% to about 99% by weight of maple syrup produced from maple sap; from about 0.3% to about 8% by weight of chipotle; from about 0.8% to about 1.5% by weight of lemongrass tea;
and from about 0.25% to about 1% by weight of chilies.

16. The process of claim 13, wherein the flavour-infused maple syrup comprises from about 96% to about 99% by weight of maple syrup produced from maple sap; from about 0.3% to about 8% by weight of nutmeg; from about 0.5% to about 1.5% by weight of cinnamon; and
from about 0.25% to about 0.8% by weight of cloves.

17. The process of claim 13, wherein the flavour-infused maple syrup comprises from about 96% to about 99% by weight of maple syrup produced from maple sap; from about 0.3% to about 8% by weight of nutmeg; from about 0.5% to about 1.5% by weight of cinnamon; and
from about 0.25% to about 0.8% by weight of cloves.

18. The process of claim 13, wherein the flavour-infused maple syrup comprises from about 70% to about 85% by weight of maple syrup produced from maple sap; from about 10% to about 20% by weight of apple cider vinegar; and from about 2% to about 8% by weight of ginger.

19. The process of claim 10, wherein in step (d), the mixture is maintained at ambient temperature for a period of about 24 hours.

20. The process of claim 10, further comprising the steps of:
filtering the infused maple syrup while it is hot;
transferring the infused maple syrup to a storage vessel that is sterilized; and
sealing the storage vessel.
